(19) United States
(12) Patent Application Publication
(10) Pub. No.: US 2025/0156849 A1
(43) Pub. Date: May 15, 2025

(54) NFT-BASED PRODUCT CYCLE MANAGEMENT SYSTEM AND METHOD AND COMPUTER PROGRAM PRODUCT

(71) Applicants: Eric Sung-Chun Chou, Taipei City (TW); Snowbridge Inc., Taipei City (TW)

(72) Inventor: Eric Sung-Chun Chou, Taipei City (TW)

(73) Assignees: Eric Sung-Chun Chou, Taipei City (TW); Snowbridge Inc., Taipei City (TW)

(21) Appl. No.: 18/647,523

(22) Filed: Apr. 26, 2024

(30) Foreign Application Priority Data
Nov. 10, 2023 (TW) 112143561

(51) Int. Cl. G06Q 20/36; G06Q 20/38

(52) U.S. Cl. CPC G06Q 20/3672; G06Q 20/389

(57) ABSTRACT

An NFT-based product cycle management system, an NFT-based product cycle management method, and a computer program product are provided. The product cycle management system is coupled to a blockchain and includes a wallet management device and an application service device coupled to the wallet management device. The application service device is configured to mint part NFTs at the blockchain. The application service device is also configured to, in accordance with part types and corresponding part quantities of parts included in each product, transfer corresponding part NFTs to a corresponding product wallet. The application service device is also configured to, during a return merchandise authorization operation for one of returned products among one or more products, transfer the part NFTs in a product wallet corresponding to the returned product to at least one selected from the group consisting of a inventory wallet, a scrap wallet, and a repair wallet.

### CROSS-REFERENCE TO RELATED APPLICATION

This non-provisional application claims priority under 35 U.S.C. § 119 (a) to Patent Application No. 112143561 filed in Taiwan, R.O.C. on Nov. 10, 2023, the entire contents of which are hereby incorporated by reference.

### BACKGROUND

### Technical Field

The instant disclosure relates to a product management system, especially to an NFT-based product cycle management system, an NFT-based product cycle management method, and a computer program product.

### Related Art

Because of climate change, carbon reduction has become a consensus worldwide. If companies can introduce a cycling design of recycling and reusing during product manufacturing, footprints of cycling and reusing of the parts of the products can be recorded in detail. Such records can be used to calculate reduction of carbon emission due to recycled product and can therefore prove the effect of carbon reduction and help obtain carbon credit. Through tracking carbon footprints of cycling parts, repair strategies which conform to the goal of carbon reduction can be drafted. Besides, products which lead to less carbon emission can be designed.

### SUMMARY

In view of this, an embodiment of the instant disclosure provides an NFT (non-fungible token)-based product cycle management system. The NFT-based product cycle management system is coupled to a blockchain and includes a wallet management device and an application service device. The wallet management device is configured to store at least one inventory wallet, at least one product wallet, at least one scrap wallet, and at least one repair wallet. Each of the at least one product wallet corresponds to a corresponding one of at least one product. The application service device is coupled to the wallet management device. The application service device is configured to mint a plurality of part NFTs at the blockchain. The part NFTs correspond to a plurality of part types and a plurality of part quantities respectively corresponding to the part types which are included in part stocking information. After the part NFTs are minted, the part NFTs are first transferred to one of the at least one inventory wallet. Next, the application service device is also configured to, in accordance with the part types and the part quantities respectively corresponding to the part types of a plurality of parts included in each of the at least one product, transfer the part NFTs corresponding to the at least one product from the one of the at least one inventory wallet to a product wallet among the at least one product wallet corresponding to the at least one product. Then, the application service device transfers replacement part NFTs corresponding to repair to a corresponding one of the at least one repair wallet. The application service device is also configured to, during a return merchandise authorization (RMA) operation for a returned product among the at least one product, transfer the part NFTs in a product wallet among the at least one product wallet corresponding to the returned product from the at least one product to at least one selected from the group consisting of the at least one inventory wallet, the at least one scrap wallet and the at least one repair wallet.

The instant disclosure provides an NFT-based product cycle management method and a computer program. The computer program is configured to be loaded by an electronic device and then execute the NFT-based product cycle management method. The NFT-based product cycle management method includes: minting a plurality of part NFTs at a blockchain, wherein the part NFTs correspond to a plurality of part types and a plurality of part quantities respectively corresponding to the part types which are included in part stocking information, and the part NFTs are transferred to one of at least one inventory wallet after the part NFTs are minted; creating at least one product wallet, wherein each of the at least one product wallet corresponds to a corresponding one of at least one product; in accordance with the part types and the part quantities respectively corresponding to the part types of a plurality of parts included in each of the at least one product, transferring the part NFTs corresponding to each of the at least one product from the one of the at least one inventory wallet to a product wallet among the at least one product wallet corresponding to the at least one product; and during a return merchandise authorization (RMA) operation for a returned product among the at least one product, transferring the part NFTs in a product wallet among the at least one product wallet corresponding to the returned product from the at least one product to at least one selected from the group consisting of at least one inventory wallet, at least one scrap wallet and at least one repair wallet.

According to the NFT-based product cycle management system, the NFT-based product cycle management method, and the computer program product provided in some embodiments of the instant disclosure, the blockchain is used to ensure the reliability of data. In addition, a footprint of each of the parts can be obtained through a transaction history of each of the part NFTs, so that the management efficiency of recycling can be enhanced. Besides, each of the part NFTs can record a greenhouse gas emission amount of a corresponding one of the parts, so that an efficiency of carbon footprint verification can be increased. Further, through issuing carbon credit tokens using blockchain, an effect of carbon reduction facilitated by recycling can be calculated more easily.

### BRIEF DESCRIPTION OF THE DRAWINGS

The instant disclosure will become more fully understood from the detailed description given herein below for illustration only, and therefore not limitative of the instant disclosure, wherein:

FIG. 1 illustrates a structural diagram of an NFT-based product cycle management system according to an embodiment of the instant disclosure;

FIG. 2 illustrates a flowchart of an NFT-based product cycle management method according to an embodiment of the instant disclosure;

FIG. 3 illustrates a flowchart of minting an NFT according to an embodiment of the instant disclosure; and

FIG. 4 illustrates a flowchart of transferring an NFT according to an embodiment of the instant disclosure.

### DETAILED DESCRIPTION

Regarding the term “couple/coupled/coupling” used in the instant disclosure, it refers to two or more elements “directly” in contact physically or electrically, or it refers to two or more elements “indirectly” in contact physically or electrically. Thereby, the elements coupled to each other interact with each other, such as for communication and control.

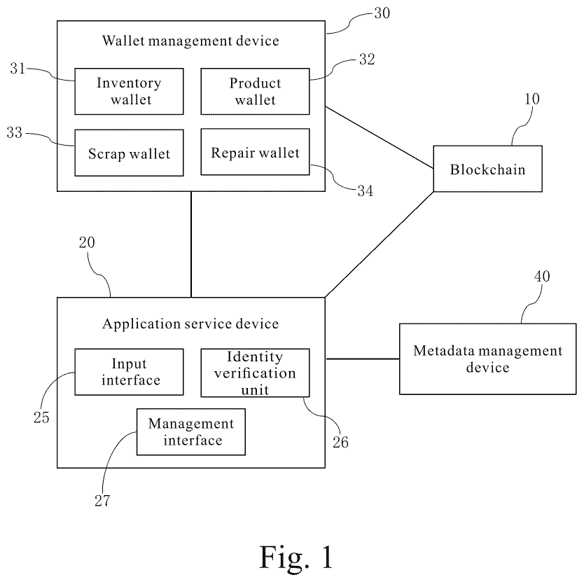

Refer to FIG. 1. FIG. 1 illustrates a structural diagram of an NFT-based product cycle management system (referred to as a “product cycle management system” hereinafter) according to an embodiment of the instant disclosure. The product cycle management system is coupled to a blockchain 10 and includes: an application service device 20 and a wallet management device 30 coupled to the application service device 20.

The wallet management device 30 may be one or more electronic devices having a storage medium; for example, the wallet management device 30 may be a server, a computer, or a storage device (such as a nonvolatile memory). The wallet management device 30 is configured to store at least one inventory wallet 31, at least one product wallet 32, at least one scrap wallet 33, and at least one repair wallet 34. In FIG. 1, the inventory wallet 31, the product wallet 32, the scrap wallet 33, and the repair wallet 34 are each exemplified as being one wallet, but the instant disclosure is not limited thereto. In some embodiments, the inventory wallet 31, the product wallet 32, the scrap wallet 33, and the repair wallet 34 may each be a plurality of wallets. The inventory wallet 31, the product wallet 32, the scrap wallet 33, and the repair wallet 34 may be located in one management device or may be distributed in a plurality of management devices. Each product wallet 32 corresponds to a product. The foregoing action of storing a wallet refers to storing a private key corresponding to the wallet. An address of the wallet may be calculated and obtained (such as through hash function or coding), in accordance with an address protocol of the blockchain 10, through another key (also referred to as a public key) which is matched with the private key. The public key and the private key may be generated through asymmetric cryptography.

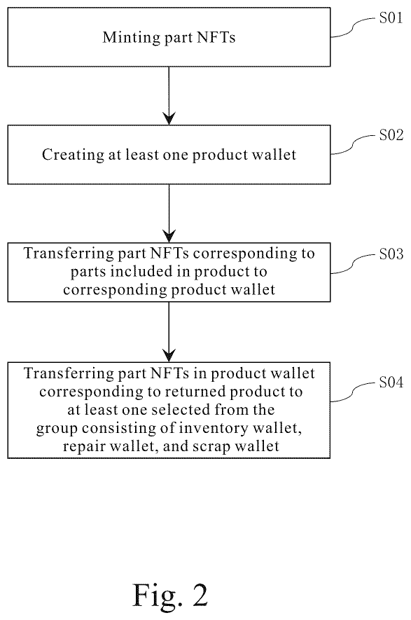

The application service device 20 is an electronic device, such as a server, a computer, a tablet computer, or a smart phone, which allows operation of personnel and is thus able to load a computer program to execute an NFT-based product cycle management method. Refer to FIG. 2. FIG. 2 illustrates a flowchart of the NFT-based product cycle management method according to an embodiment of the instant disclosure.

In the step S01, a plurality of part NFTs are minted at the blockchain 10. The part NFTs correspond to a plurality of part types and a plurality of part quantities respectively corresponding to the part types, and the plurality of part types and the plurality of part quantities are included in part stocking information. That is, in some embodiments, one NFT is minted for each of the parts in the part stocking information in batch, and each of the NFTs corresponds to a corresponding one of the parts. The part stocking information is obtained from a storage management system which records a list of all of the parts which are stocked.

In the step S02, at least one product wallet 32 is created. For the sake of convenience in illustrating the embodiments, in the following paragraphs, the numbers of the inventory wallet 31, the product wallet 32, the scrap wallet 33, the repair wallet 34, and the product may be one or more. Each product wallet 32 corresponds to a corresponding product. Besides, it is understood that, the inventory wallet 31, the scrap wallet 33, and the repair wallet 34 mentioned above may also be created in the step S02, but the instant disclosure is not limited thereto. After the wallet/wallets is/are created, the application service device 20 will initiate a wallet registration transaction, i.e., register a wallet address calculated based on the public key of the wallet(s).

In the step S03, in accordance with the part types and the part quantities respectively corresponding to the part types of the plurality of parts included in each product, the part NFTs corresponding to the product are transferred to a product wallet 32 corresponding to the product. In some embodiments, after the part NFTs are minted, the part NFTs are transferred to and kept in one of the inventory wallets 31. Therefore, that the corresponding ones of the parts are in stock can be indicated. After the parts are assembled into a product, the part NFTs corresponding to the parts which have been assembled are transferred from the inventory wallet 31 to the product wallet 32 corresponding to the product. In some embodiments, some of the parts serve as spare parts for repair, and therefore each of the part NFTs corresponding to the spare parts is transferred to a corresponding one of the repair wallets 34.

In the step S04, during a return merchandise authorization (RMA) operation for a product (referred to as a “returned product” hereinafter) among the products, the part NFTs extracted from a product wallet 32 corresponding to the returned product are transferred to at least one selected from the group consisting of the scrap wallet 33, the repair wallet 34, and the inventory wallet 31. Therefore, that the corresponding ones of the parts are scrapped, serve as the spare parts for repair, or recycled and reused can be indicated. On the other hand, that one of the part NFTs from one of the repair wallets 34 is transferred to a product wallet 32 corresponding to the returned product indicates that a part corresponding to the part NFT from the repair wallet 34 has been used to replace a part which has been taken out and scrapped during repair.

For example, when some of the parts of the returned product are damaged, the parts which are damaged may be replaced with the replacement parts. Thereby, the returned product is repaired into a refurbished product with normal functions. In the step S04, the part NFTs (i.e., the replacement part NFTs) in the repair wallet 34 corresponding to the replacement parts are transferred to the product wallet 32 corresponding to the returned product, and the part NFTs (i.e., defective part NFTs) corresponding to defective parts are transferred to the scrap wallet 33. The replacement parts and the scrap parts mentioned above have identical ones of the part types and identical ones of the part quantities.

When the returned product is severely damaged and cannot be repaired into the refurbished product, parts which are usable (i.e., non-defective parts) in the returned product can serve as the spare parts for repair or recyclable parts. Therefore, each of the part NFTs corresponding to the non-defective parts (i.e., non-defective part NFTs) is transferred to one of the repair wallets 33 or one of the inventory wallets 31. The parts which are unusable (i.e., the defective parts) in the returned product are retrieved and scrapped. Therefore, each of the part NFTs corresponding to the defective parts (i.e., defective part NFTs) is transferred to one of the scrap wallets 33.

Refer to FIG. 1. In some embodiments, the product cycle management system further includes a metadata management device 40. The metadata management device 40 may be a file storage system, such as an InterPlanetary File System (IPFS) or a file server of another type. The metadata management device 40 is configured to store a metadata corresponding to each of the part NFTs. Each of the metadata records at least one selected from the group consisting of a part name, a part number, a serial number, a date (manufacture date and/or stock date), a specification, a greenhouse gas emission amount, and inventory information. The inventory information may be, for example, in which warehouse the part corresponding to the metadata is stored or a batch number of the part corresponding to the metadata. In some embodiments, the metadata are JSON (JavaScript Object Notation) files. Each of the part NFTs records an access link. Each of the access links directs to a corresponding one of the JSON files stored at the metadata management device 40. That is, through each of the access links, the metadata management device 40 can be accessed, and the corresponding one of the JSON files can be obtained. The access links may for example be uniform resource locators (URLs). In some embodiments, storage resources external to the product cycle management system can be used to store the metadata, and thus the metadata management device 40 is not necessarily to be established in the product cycle management system.

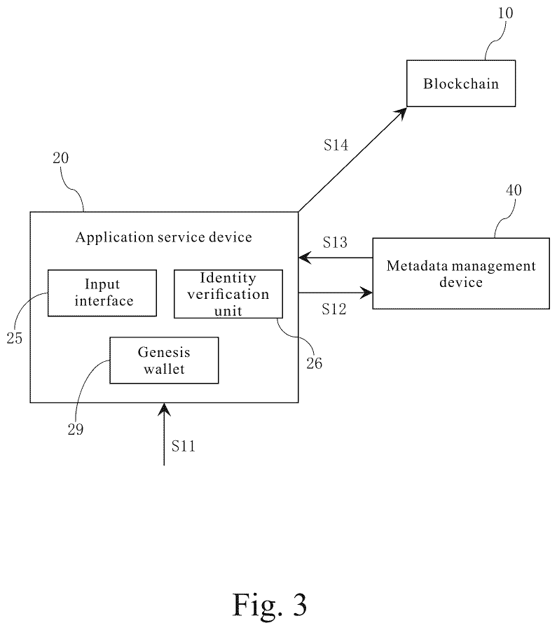

Refer to FIG. 3. FIG. 3 illustrates a flowchart of minting an NFT according to an embodiment of the instant disclosure. The application service device 20 includes an input interface 25 which is operable by personnel. The input interface 25 includes, but not limited to, at least one selected from the group consisting of a keyboard, a mouse, and a barcode reader. The application service device 20 includes an genesis wallet 29 for storing NFTs which have been minted. In the step S11, the personnel inputs a minting command through the input interface 25 so that the application service device 20 executes an NFT minting function, and the personnel also inputs required data (i.e., information to be recorded in the metadata, and the information relates to the parts corresponding to the part NFTs to be minted). In the step S12, the metadata management device 40 creates and stores the metadata having the information which has been inputted. In the step S13, the access link which is returned by the metadata management device 40 and directs to the file of the metadata is received. In the step S14, a transaction of NFT minting is initiated for the blockchain 10, a token ID of the part NFT which has been minted is obtained, and the part NFT which has been minted is stored in the genesis wallet 29 by default.

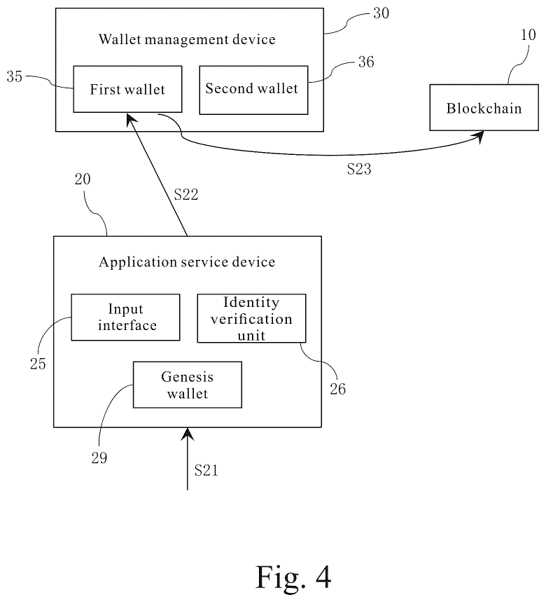

Refer to FIG. 4. FIG. 4 illustrates a flowchart of transferring an NFT according to an embodiment of the instant disclosure. In the step S21, the personnel inputs a transfer command through the input interface 25 so that the application service device 20 executes an NFT transferring function, and the personnel also inputs required information. The foregoing information includes a numbering of the part NFT to be transferred and includes from which wallet (source wallet) to which wallet (destination wallet) should the part NFT be transferred. Here, that the part NFT is to be transferred from a first wallet 35 to a second wallet 36 is exemplified. The first wallet 35 may be selected from the inventory wallet 31, the product wallet 32, the scrap wallet 33, the repair wallet 34, and the genesis wallet 29. The second wallet 36 may be selected from the inventory wallet 31, the product wallet 32, the scrap wallet 33, and the repair wallet 34. The first wallet 35 and the second wallet 36 are not the same wallet. In the step S22, the first wallet 35 is accessed. In the step S23, the transaction of NFT transferring is initiated for the blockchain, so that the NFT part of a designated numbering is transferred from the first wallet 35 to the second wallet 36.

Refer to FIG. 1. The application service device 20 further includes an identity verification unit 26. The identity verification unit 26 is configured to verify personnel and log in a user account of the personnel. Verification methods include, but not limited to, password, biological identification (such as using a fingerprint or facial recognition), or device verification (such as using a Passkey technology). The identity verification unit 26 is configured to selectively authorize a plurality of users with at least one selected from a plurality of operation authorities, and the operation authorities include a wallet creation authority, an NFT minting authority, and an NFT transferring authority. In other words, in some embodiments, each account can be, in accordance with a professional authority of the personnel, authorized with the wallet creation authority for wallet creation, the NFT minting authority for NFT minting, and/or the NFT transferring authority for NFT transferring. For example, purchase management personnel may have the NFT minting authority. Therefore, the purchase management personnel can mint part NFTs corresponding to purchased parts and then transfer the part NFTs to the inventory wallets 31 corresponding to different warehouses. For another example, product management personnel may have the wallet creation authority and the NFT transferring authority. Therefore, the product management personnel can create the product wallet 32 for a manufactured product and then transfer the part NFTs corresponding to all of the parts of the product from the inventory wallet 31 to a corresponding one of the product wallets 32. For yet another example, repair personnel may have the NFT transferring authority. Therefore, the repair personnel can transfer some of the part NFTs to corresponding wallets in accordance with a replacement of parts.

In detail, according to some embodiments, when the repair personnel replaces a damaged part of a returned product with a replacement part, the application service device 20 acquires an address of the product wallet 32 corresponding to the returned product from the returned product through the input interface 25. For example, the product may have a QR code, the QR code is scanned by the input device 25 and deciphered, and then the address is acquired. Therefore, the application service device 20 can locate the product wallet 32 corresponding to the returned product through the address. Next, the repair personnel inputs a part number of the replacement part and a part number of the damaged part through the input interface 25. Thereby, the application service device 20 can find the part NFT corresponding to the replacement part from the repair wallet 34 through the part number of the replacement part and can find the part NFT corresponding to the damaged part from the product wallet 32 corresponding to the returned product through the part number of the damaged part. Therefore, the application service device 20 transfers the part NFT of the replacement part to the product wallet 32 corresponding to the returned product and transfers the part NFT of the damaged part to the scrap wallet 33. In some embodiments, when the part NFT corresponding to the part number of the replacement part cannot be found in the repair wallet 34, the application service device 20 can look for the part NFT in the inventory wallet 31. When the part NFT still cannot be found, the application service device 20 then can mint the replacement part NFT which corresponds to the part type and the part quantity corresponding to the part type of the replacement part.

Refer to FIG. 1. The application service device 20 further includes a management interface 27 which allows the personnel to operate so as to read management information and look up a cycle footprint. For example, the personnel can input the numbering of the part NFT of a specific one of the parts through the input interface 25. Next, the application service device 20 can look up the transaction history of this part NFT at the blockchain 10 in accordance with the numbering so as to acquire the cycle footprint corresponding to this part and display the cycle footprint on the management interface 27. In other words, in some embodiments, through acquiring to which wallets has the part NFT corresponding to this part been transferred, the cycle footprint of this part can be learned. For another example, the personnel can look up the greenhouse gas emission amount of each of the parts and/or each of the wallets through the management interface 27. The application service device 20 sums up the greenhouse gas emission amount recorded in the metadata corresponding to each of the part NFTs in each of the product wallet 32, the inventory wallet 31, the repair wallet 34, and the scrap wallet 33 and displays the summed results on the management interface 27. Thus, the greenhouse gas emission amount and a trend of the greenhouse gas emission amount of each of the wallets can be acquired. Besides, the management interface 27 can also allow the personnel to look up statistics of the transactions of the part NFTs in the repair wallet 34 and the scrap wallet 33 within a specific period, so that life cycles of materials can be analyzed, and carbon-reducing designs of the products can be facilitated. The management interface 27 can also allow the personnel to look up a rank of the defective part NFTs and an analysis of a trend of the defective part NFTs, so that which part is likely to be damaged can be learned, and this information can be provided as reference for later improvements on product designs and manufacture processes. The management interface 27 can also allow the personnel to look up the information of the part NFTs in the product wallet 32, so that an impact of the greenhouse gas emission amounts of the repair and an impact of the greenhouse gas emission amounts of the RMA operation can be learned, and this information can be provided to assist in drafting and executing a repair strategy of the RMA operation.

In some embodiments, the product cycle management system can further perform vertical integration. Specifically, in some embodiments, the product cycle management system can issue carbon credit tokens which are used for marking a carbon emission reduced after recycling. The carbon credit tokens are automatically minted in accordance with a smart contract during recycling, and the carbon credit tokens are transferred to recyclers. Accumulated carbon credit tokens may be transformed into carbon credit certificates (or carbon credit encrypted currency) through a verification agency and used for carbon credit transaction in the future. The carbon credit token may also be transferred to the product wallet 32 corresponding to a recycled product, so as to mark a carbon emission amount reduced throughout the history of the product.

In some embodiments, in response to that a part is scrapped after being recycled (such as handed to a recycler for further reuse), the application service device 20 burns the part NFT in the scrap wallet 33 corresponding to the scrapped part. That is, in some embodiments, the application service device 20 initiates a transaction of burning the part NFT at the blockchain 10.

The foregoing blockchain 10 may be a public chain, a private chain, or a consortium blockchain, and the instant disclosure is not limited thereto. According to the NFT-based product cycle management system, the NFT-based product cycle management method, and the computer program product provided in some embodiments of the instant disclosure, the blockchain 10 is used to ensure the reliability of the data. In addition, the footprint of each of the parts can be obtained through the transaction history of each of the part NFTs, so that the management efficiency of recycling can be enhanced. Besides, each of the part NFTs can record the greenhouse gas emission amount of a corresponding one of the parts, so that the efficiency of carbon footprint verification can be increased. Further, through issuing carbon credit tokens using the blockchain 10, the effect of carbon reduction facilitated by recycling can be calculated more easily.

What is claimed is:

1. An NFT-based product cycle management system coupled to a blockchain, wherein the NFT-based product cycle management system comprises:
a wallet management device configured to store at least one inventory wallet, at least one product wallet, at least one scrap wallet, and at least one repair wallet, wherein each of the at least one product wallet corresponds to a corresponding one of at least one product; and
an application service device coupled to the wallet management device, wherein the application service device is configured to mint a plurality of part NFTs at the blockchain, the part NFTs correspond to a plurality of part types and a plurality of part quantities respectively corresponding to the part types which are included in part stocking information, the application service device is also configured to, in accordance with the part types and the part quantities respectively corresponding to the part types of a plurality of parts included in each of the at least one product, transfer the part NFTs corresponding to the at least one product to a product wallet among the at least one product wallet corresponding to the at least one product, and the application service device is also configured to, during a return merchandise authorization (RMA) operation for a returned product among the at least one product, transfer the part NFTs in a product wallet among the at least one product wallet corresponding to the returned product from the at least one product to at least one selected from the group consisting of the at least one inventory wallet, the at least one scrap wallet and the at least one repair wallet.

2. The NFT-based product cycle management system according to claim 1, wherein during the RMA operation, the part NFTs in the product wallet corresponding to the returned product comprise at least one non-defective part NFT corresponding to at least one non-defective part and comprise at least one defective part NFT corresponding to at least one defective part, and the application service device is configured to transfer the at least one non-defective part NFT to the at least one repair wallet or the at least one inventory wallet and transfer the at least one defective part NFT to the at least one scrap wallet.

3. The NFT-based product cycle management system according to claim 1, wherein during the RMA operation, the part NFTs in the product wallet corresponding to the returned product comprise at least one non-defective part NFT corresponding to at least one non-defective part and comprise at least one defective part NFT corresponding to at least one defective part, and the application service device is configured to transfer at least one replacement part NFT which is in the at least one repair wallet and corresponds to at least one replacement part to the product wallet corresponding to the returned product, and the application service device is also configured to transfer the at least one defective part NFT to the at least one scrap wallet, wherein the at least one replacement part and the at least one defective part have identical ones of the part types and identical ones of the part quantities.

4. The NFT-based product cycle management system according to claim 3, wherein the application service device comprises an input interface so as to acquire an address of the product wallet corresponding to the returned product from the returned product, the application service device is further configured to mint the at least one replacement part NFT at the blockchain, the at least one replacement part NFT corresponds to the part type of the at least one replacement part and corresponds to the part quantity corresponding to the part type of the at least one replacement part, the application service device is further configured to transfer the at least one replacement part NFT to the at least one repair wallet, and that the application service device transfers the at least one replacement part NFT to the product wallet corresponding to the returned product indicates that the application service device transfers the at least one replacement part NFT in the at least one repair wallet to the product wallet corresponding to the address.

5. The NFT-based product cycle management system according to claim 1, wherein the application service device is configured to inquire a transaction history of one of the part NFTs in accordance with a numbering of the one of the part NFTs so as to obtain a cycle footprint of the part corresponding to the one of the part NFTs.

6. The NFT-based product cycle management system according to claim 1, wherein the at least one inventory wallet is configured to hold some of the part NFTs corresponding to the part stocking information.

7. The NFT-based product cycle management system according to claim 6, wherein the application service device is configured to sum up a greenhouse gas emission amount recorded in a metadata corresponding to each of the part NFTs in each of the at least one product wallet, the at least one inventory wallet, the at least one repair wallet, and the at least one scrap wallet.

8. The NFT-based product cycle management system according to claim 1, further comprising:
a metadata management device coupled to the application service device and configured to store a metadata corresponding to each of the part NFTs, wherein the metadata records at least one selected from the group consisting of a part name, a part number, a serial number, a date, a specification, a greenhouse gas emission amount, and inventory information.

9. The NFT-based product cycle management system according to claim 1, wherein the application service device comprises an identity verification unit, the identity verification unit is configured to selectively authorize a plurality of users with at least one selected from a plurality of operation authorities, and the operation authorities comprise a wallet creation authority, an NFT minting authority, and an NFT transferring authority.

10. An NFT-based product cycle management method comprising:
minting a plurality of part NFTs at a blockchain, wherein the part NFTs correspond to a plurality of part types and a plurality of part quantities respectively corresponding to the part types which are included in part stocking information;
creating at least one product wallet, wherein each of the at least one product wallet corresponds to a corresponding one of at least one product;
in accordance with the part types and the part quantities respectively corresponding to the part types of a plurality of parts included in each of the at least one product, transferring the part NFTs corresponding to each of the at least one product to a product wallet among the at least one product wallet corresponding to the at least one product; and
during a return merchandise authorization (RMA) operation for a returned product among the at least one product, transferring the part NFTs in a product wallet among the at least one product wallet corresponding to the returned product from the at least one product to at least one selected from the group consisting of at least one inventory wallet, at least one scrap wallet and at least one repair wallet.

11. The NFT-based product cycle management method according to claim 10, wherein during the RMA operation, the part NFTs in the product wallet corresponding to the returned product comprise at least one non-defective part NFT corresponding to at least one non-defective part and comprise at least one defective part NFT corresponding to at least one defective part, and the NFT-based product cycle management method further comprises:
transferring the at least one non-defective part NFT to the at least one repair wallet or the at least one inventory wallet; and
transferring the at least one defective part NFT to the at least one scrap wallet.

12. The NFT-based product cycle management method according to claim 10, wherein during the RMA operation, the part NFTs in the product wallet corresponding to the returned product comprise at least one non-defective part NFT corresponding to at least one non-defective part and comprise at least one defective part NFT corresponding to at least one defective part, and the NFT-based product cycle management method further comprises:
transferring at least one replacement part NFT which is in the at least one repair wallet and corresponds to at least one replacement part to the product wallet corresponding to the returned product, wherein the at least one replacement part and the at least one defective part have identical ones of the part types and identical ones of the part quantities; and
transferring the at least one defective part NFT to the at least one scrap wallet.

13. The NFT-based product cycle management method according to claim 12, further comprising:
acquiring an address of the product wallet corresponding to the returned product from the returned product;
minting the at least one replacement part NFT at the blockchain, wherein the at least one replacement part NFT corresponds to the part type of the at least one replacement part and corresponds to the part quantity corresponding to the part type of the at least one replacement part; and
transferring the at least one replacement part NFT to the at least one repair wallet;
wherein, that the application service device transfers the at least one replacement part NFT to the product wallet corresponding to the returned product indicates that the application service device transfers the at least one replacement part NFT in the at least one repair wallet to the product wallet corresponding to the address.

14. The NFT-based product cycle management method according to claim 10, further comprising:
inquiring a transaction history of one of the part NFTs in accordance with a numbering of the one of the part NFTs so as to obtain a cycle footprint of the part corresponding to the one of the part NFT.

15. The NFT-based product cycle management method according to claim 10, wherein some of the part NFTs corresponding to the part stocking information are held in the at least one inventory wallet.

16. The NFT-based product cycle management method according to claim 15, further comprising:
summing up a greenhouse gas emission amount recorded in a metadata corresponding to each of the part NFTs in each of the at least one product wallet, the at least one inventory wallet, the at least one repair wallet, and the at least one scrap wallet.

17. The NFT-based product cycle management method according to claim 10, wherein a metadata corresponding to each of the part NFTs records at least one selected from the group consisting of a part name, a part number, a serial number, a date, a specification, a greenhouse gas emission amount, and inventory information.

18. A computer program product configured to be loaded by an electronic device and then execute the NFT-based product cycle management method according to claim 10.
